(19) United States
(12) Patent Application Publication
(10) Pub. No.: US 2003/0014323 A1
(43) Pub. Date: Jan. 16, 2003

(54) Computer system and method for ordering a product

(76) Inventor: Jan Scheer, Fuerth (DE)

Correspondence Address: WHITE & CASE LLP, PATENT DEPARTMENT, 1155 AVENUE OF THE AMERICAS, NEW YORK, NY, 10036, US

(21) Appl. No.: 09/967,590

(22) Filed: Sep. 28, 2001

(30) Foreign Application Priority Data
Jul. 16, 2001 (DE) 10134541.0

(51) Int. Cl. G06F 17/60

(52) U.S. Cl. 705/26

(57) ABSTRACT

The invention relates to a method and to a computer system for ordering a product, having a server database for storing a list of products and a price for each of the products, a web page for a client to select and order the product from the list of products, and means for charging the amount of the order to an account of a user of the client.

The invention relates to a computer system and to a method for ordering a product, in particular food, drink or tobacco, over a computer network.

It is known practice from the prior art to order books, CDs, clothing and other products over the Internet by virtue of a user using a client PC to select appropriate products from a catalog system via web pages of an online shop and paying for them by means of credit card, invoice or automatic debit transfer.

A drawback for the user in this context is that it is relatively time-consuming to select the desired product from the vast number of products offered by the catalog system. In terms of processing the payment, another drawback is that entering the credit card number carries an associated security risk; the same applies for entering the account details for the automatic debit transfer. On the other hand, payment by invoice is associated with a high level of administrative complexity and with a high risk for the online shop that the invoice will not be paid.

Corresponding systems are also known for online ordering of food:

U.S. Pat. No. 5,504,589 discloses a portable appliance for transmitting food orders to a central station. The portable unit contains a memory having a list of foods that can be selected for an order. The portable unit has a wireless interface for transmitting relevant orders entered into the portable unit by a user to the central station. This system is provided for the communication between a kitchen and a food server.

U.S. Pat. No. 6,204,763 discloses a system for automatically delivering consumables for a household having an intelligent refrigerator. The refrigerator has an inventory system with sensors for creating a list of products to be reordered. The refrigerator also has an automatic ordering system with a telecommunication appliance that is connected to the inventory processor in order to transmit an appropriate order list to a vendor automatically.

U.S. Pat. No. 6,246,998 discloses an Internet-based method for purchasing vegetables. In this case, a user fills a virtual shopping basket with the selected vegetables and receives from the server additional information regarding the volume and weight of the products purchased.

The invention is based on the object of providing an improved computer system and method for ordering a product, in particular food, drink or tobacco.

The object on which the invention is based is achieved in each case by the features of the independent patent claims.

Preferred embodiments of the invention are specified in the dependent claims.

The present invention allows the selection, ordering and purchasing of, and also paying for, products over a computer network to be made convenient, efficient and secure. In this context, a particularly significant feature is that a list of products is stored on the server, so that a user does not first have to create such a list himself, for example by filling a shopping basket.

A great diversity of products, i.e. goods and/or services, can be involved in this context. By way of example, the products may be

requesting the provision of services, e.g., within the context of maintenance contracts for installations/software/machinery,

requesting the delivery of spare parts, or any other products.

In one preferred embodiment of the invention, a plurality of lists of products is stored on the server. An administrator of the server can select one of these lists of products, so that only the selected list of products is available on the client for selecting and ordering products. At regular or irregular intervals of time, e.g., once daily, the administrator can change the selection of the list of products, so that different lists of products for selecting and ordering products are available on the client at different times. This makes it possible to offer a wide range of products without overtaxing the user with a confusing offer.

In another preferred embodiment of the invention, the products ordered are paid for on the server by charging the amount of the order to an account of the user. In this context, one or more credit limits can be defined for the user which, when reached, either cause a warning to be generated for the user and/or cause the order to be rejected.

The account can be filled without the use of cash, for example by transferring an amount to the operator of the online shop, or else by paying in cash. In the latter case, an administrator accesses an appropriate database on the server in order to credit the account of the user with the amount paid in.

In another preferred embodiment of the invention, payment is made on the client, e.g., using a smart card. The smart card stores the account balance of the user and also his credit limit. The client computer of the user is equipped with a card reader for the smart card, so that, when an order is placed, the client computer uses the card reader to access the smart card in order to make an appropriate charge to the account of the user, provided that the credit limit has not been exceeded.

One particularly advantageous application of the invention is to use it for selecting and ordering food, drink or tobacco, in particular for selecting food, e.g., in a company canteen, a restaurant, from a catering service or other suppliers of meals and/or beverages.

In this case, a menu list for the food selection and/or the selection of beverages is stored on the server. This list may be the menu of the canteen or of the restaurant, for example.

In one preferred embodiment of the invention, various standardized menus, which can be selected by an administrator, are stored on the server. By way of example, a different menu associated with a different supplier and showing the standard menu thereof can be stored for each day of the week. The administrator can then select one of the standard menus for a particular day of the week, so that the appropriate orders are automatically transmitted to this supplier.

In accordance with another preferred embodiment, one or more special menus that the administrator can compile individually are stored on the server. This is the case particularly when, by way of example, the company canteen has its own kitchen.

In accordance with another preferred embodiment, the computer system has an interface for the administrator that allows the administrator also to enter manually recorded purchases, e.g., of beverages or confectionery, into the system at a subsequent time. By way of example, beverages or snacks bought for consumption between meals can be recorded manually using rosters or the like and can then be entered into the system later for the purposes of processing the payment and inventory management.

In another preferred embodiment of the invention, the smart card is used not only for payment, but also for authenticating the user. In this way, the user is saved from entering a user identifier and a password. The basis used for this can be an existing smart card system for access control in a company.

A preferred exemplary embodiment of the invention is explained in more detail below with reference to the drawings, in which:

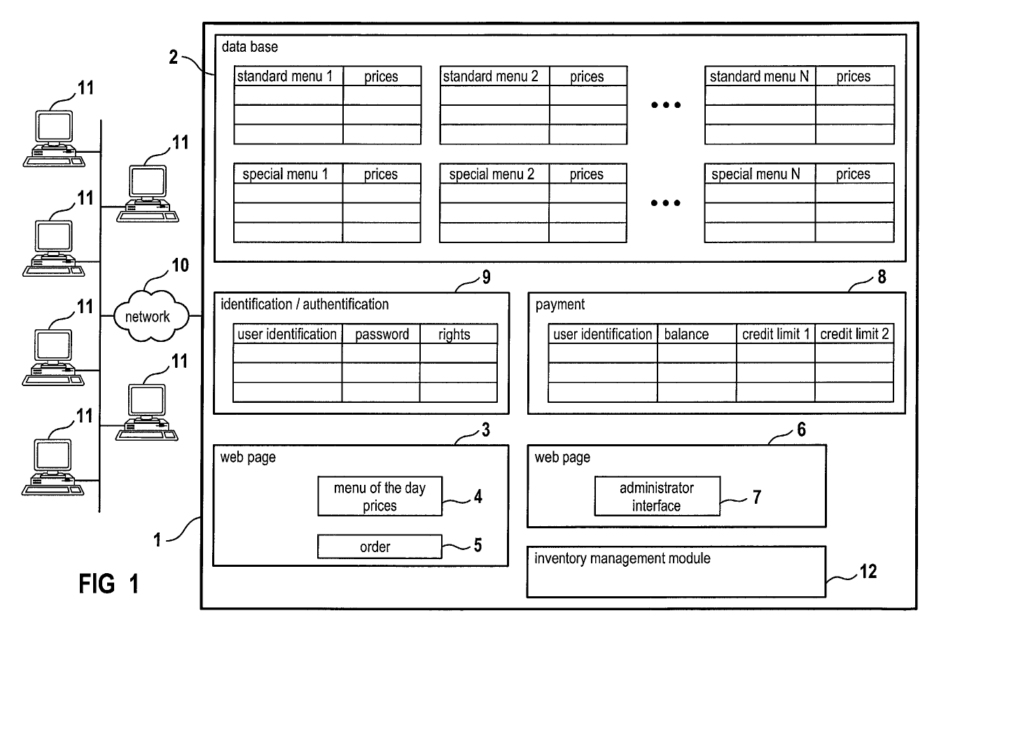

FIG. 1 shows a block diagram of a first embodiment of an inventive computer system,

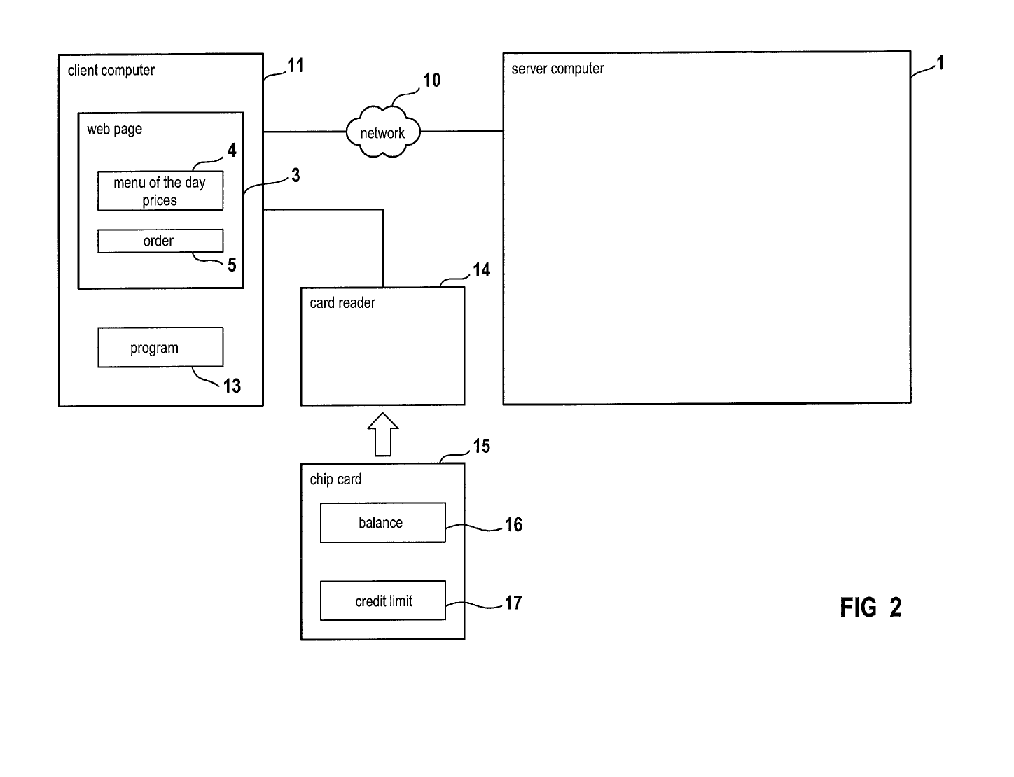

FIG. 2 shows a second embodiment of an inventive computer system,

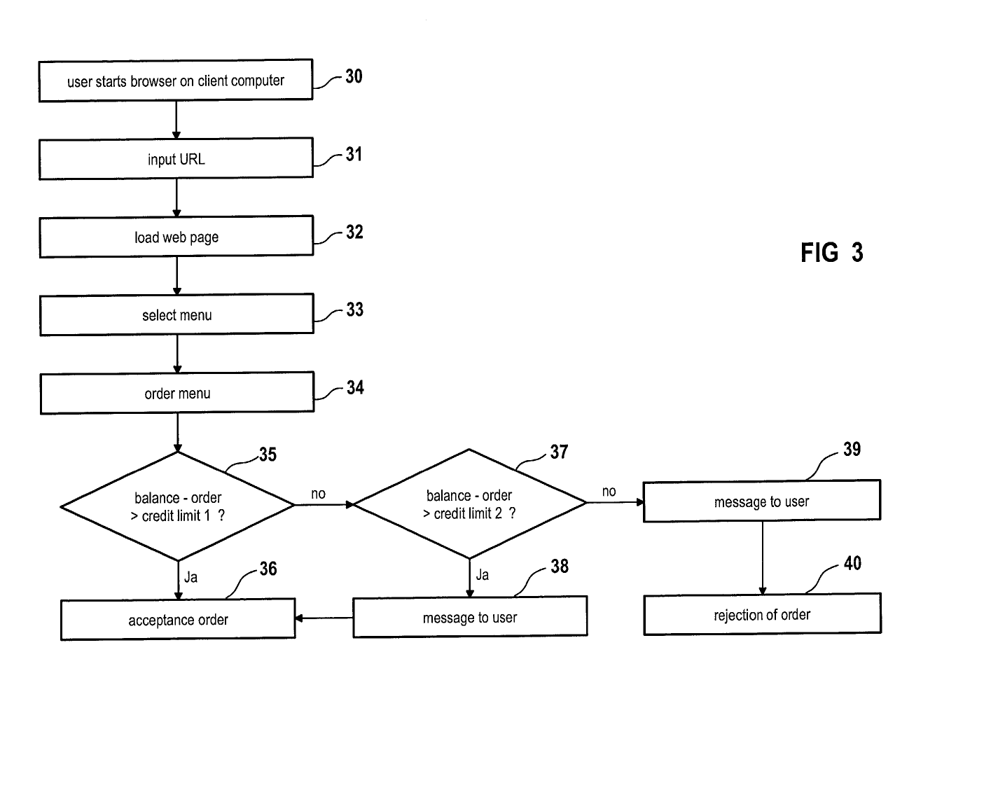

FIG. 3 shows a flowchart for an embodiment of the inventive method.

FIG. 1 shows a computer system having a server computer 1 on which an online shop is implemented. The server computer 1 has a database 2 storing lists of products. In the embodiment in FIG. 1, these lists are various menus for food selection, that is to say, the standard menus “Standard menu 1”, “Standard menu 2”, . . . “Standard menu N” and “Special menu 1”, “Special menu 2”, . . . “Special menu N”.

In this context, each food item and beverage on the standard and special menus has an associated, corresponding price. The files for the standard menus can also contain an indication of a corresponding supplier.

The server computer 1 also has a web page 3 for displaying one of the standard or special menus of the database 2. The daily menu selected by an administrator is displayed, with the corresponding prices, in an area 4 of the web page 3. A user can then select his food and a beverage in the area 4, e.g., by clicking on appropriate selection fields with the computer mouse.

The web page 3 also has a control element 5 that can be used, e.g., by clicking on it with the computer mouse, to order the selected food and beverage(s).

The server computer 1 has another web page 6 having an administrator interface 7. The administrator interface 7 can be used by an administrator to enter a special menu into the database 2, or to edit a special menu, to add or delete a standard menu, and also to select one of the standard or special menus as the daily menu. The administrator can also use the administrator interface 7 to access a database 8 for ad ministering payment operations.

The database 8 contains an account balance and also a credit limit 1 and a credit limit 2 for each registered user. The account balance and the credit limits can be accessed using the user identifier as key in the database 8. The credit limits 1 and 2 can apply globally for all users or may be user-specific or user group-specific. By way of example, particularly long-standing or good customers may be given a higher credit limit than new customers.

To create a new user, the administrator allocates a corresponding user identifier, and a credit paid in by the new user is credited to the appropriate account balance in the database 8.

This user identifier is also entered into the database 9, used for identifying and/or authenticating a user. The user identifier additionally has an associated password that the user needs to enter, together with his user identifier in order to log onto the server computer 1.

The user identifier also has the associated user rights, specifically, according to the role of the user. By way of example, a distinction can be made between normal user rights and administrator rights.

The server computer 1 also contains an inventory management module 12 for logistical processing, inventory management and the like for the orders entered by the users.

The server computer 1 can be accessed over a network 10. The network 10 can, by way of example, be an intranet within a company, an extranet or the Internet. The network 10 can also comprise a mobile network, for example, one based on the WAP protocol.

The server computer 1 is accessed over the network 10 using client computers 11. The client computers 11 can be normal personal computers equipped with a normal web browser, e.g., Netscape Navigator or Microsoft Internet Explorer. They may also be mobile computers equipped with a wireless interface, and mobile telephones with WAP capability. Personal Digital Assistants having a network interface and also “Web Pads” may likewise be used as client computers 11.

When a user having administrator rights identifies and authenticates himself to the server computer 1 by entering his user identifier and password, the web page 6 having the administrator interface 7 is loaded onto the relevant client computer 11 of the administrator. The administrator can then select the daily menu from the database 2 or access the database 8 for administrative processing of payment operations or else can access the database 9 for user administration.

If, by contrast, a user having normal user rights logs onto the server computer 1, the web page 3 is loaded onto the relevant client computer 11 of the user, so that the user can put together his food in the area 4 from the daily menu offered. After the menu has been selected, the user then operates the control element 5, so that the relevant order is transmitted to the server computer 1 over the network 11. There, a check is first carried out to determine whether the account balance in the database 8 covers the sum of the order. If this is not the case, the order can be rejected.

Alternatively, it is possible to check whether the order is within the credit limit 1. If this is the case, the order is accepted. On the other hand, if the sum of the order exceeds the credit limit 1, then the order is likewise accepted and the user additionally receives a message containing a warning regarding the credit limit 1 being exceeded. If the credit limit 2 is also exceeded, the order is rejected and the user receives an appropriate message. These messages can be sent automatically by email to the user in question, or they can be displayed to the user when he next logs onto the server computer 1.

The orders entered by the users can be collected on the server computer 1 up to a particular time, so that these orders are then collectively entered into the inventory management module 12 for logistical processing. By way of example, the food order needs to be entered by a particular time on the previous day, so that the relevant food can then be purchased freshly on the morning of the next day, which is very important particularly for fruit and vegetables.

FIG. 2 shows a block diagram of an alternative embodiment of the invention. Elements in FIG. 2, which correspond to elements in FIG. 1, have been marked by the same reference symbols.

FIG. 2 shows a situation in which a user of the client computer 11 has already logged onto the server computer 1, and the web page 3 has been transmitted to the client computer 11 and is displayed there. After the user has selected his food from the daily menu displayed in the area 4, the user operates the control element 5 to enter the order.

Operating the control element 5 automatically calls a program 13, e.g., using a script coded in the web page 3. The program 13 contains a driver for communicating with a card reader 14 connected to the client computer 11. The user is then requested to insert his smart card 15 into the card reader 14. The smart card 15 has memory areas 16 and 17. Memory area 16 is used to store the current account balance of the user, and memory area 17 is used to store the credit limit(s) of the user.

The client computer 11 then accesses memory areas 16 and 17 in order to check whether the order by the user can be accepted. If this is not the case, the user receives an appropriate message displayed on his client computer 11 and is requested to fill his smart card 15. In the opposite case, the order data for the food selection of the user are transmitted over the network 10 to the server computer 1, from where the order is processed.

If the computer system in FIG. 1 is used for other products, such as

requesting the provision of services, e.g., within the context of maintenance contracts for installations/software/machinery, or

requesting the delivery of spare parts,

the database 2 stores appropriate standard lists for such products and the prices thereof, and also appropriate special lists. The web page 3 is then used for displaying and selecting products from the respective list selected by the administrator.

FIG. 3 shows one preferred embodiment of an inventive method. In step 30, the user first starts a browser program on his client computer. In step 31, the user enters the Uniform Resource Locator (URL) of an online shop on a server computer—cf. server computer 1 in FIGS. 1 and 2.

In step 32, the appropriate web page is then loaded onto the client computer of the user from the server computer. In step 33, the user of the web page selects his food and/or beverages from the menu offered on the web page. In step 34, the user confirms his selection by means of a corresponding order.

In step 35, a check is carried out to determine whether the current account balance of the user minus the sum of the order is above his credit limit 1. If this is the case, the order is accepted in step 36.

If this is not the case, a check is carried out in step 37 to determine whether the credit limit 2 of the user has also been exceeded. If the credit limit 2 has not also been exceeded, a message to the user is generated in step 38 informing him that the credit limit 1 has been exceeded. In step 36, the order is nonetheless accepted.

If the check in step 37 reveals that the credit limit 2 would also be exceeded by the order, then an appropriate message to the user is automatically generated in step 39, after which the order is rejected. Accordingly, the order is rejected by the client computer in step 40.

What is claimed is:

1. A computer system for ordering a product, having
a server database (2) for storing a list of products and a price for each of the products,
a web page (3) for a client (11) to select and order the product from the list of products,
means (8) for charging the amount of the order to an account of a user of the client.

2. The computer system as claimed in claim 1, where the product is food, drink or tobacco and where the list of products is a menu.

3. The computer system as claimed in claim 1 or 2, in which the server database stores one or more standard lists, for example in the form of standard menus, and having an interface (6, 7) for an administrator for selecting one of the standard lists as the basis for selection and ordering by the client.

4. The computer system as claimed in claim 3, in which each of the standard lists is associated with a particular supplier.

5. The computer system as claimed in one of the preceding claims 1 to 4, in which the server database can store one or more special lists, for example in the form of special menus, and the special list can be created or edited by an administrator using an administrator interface (6, 7).

6. The computer system as claimed in one of the preceding claims 1 to 5, having means for dynamically creating the web page in order to visualize the list of products on the basis of the standard or special list selected by an administrator.

7. The computer system as claimed in one of the preceding claims 1 to 6, having a payment module (8) for storing an account balance for each registered user of the computer system.

8. The computer system as claimed in claim 7, where the payment module is designed to store a first credit limit and preferably to store a second credit limit.

9. The computer system as claimed in claim 8, having means for generating a message to the user if the order by the user exceeds the first and/or the second credit limit.

10. The computer system as claimed in one of the preceding claims 1 to 9, having means (9) for identifying and/or authenticating a user.

11. The computer system as claimed in one of the preceding claims 1 to 10, having a goods management module (12) for processing the order.

12. The computer system as claimed in one of the preceding claims 1 to 11, in which the means for charging an account of the user are implemented on the client.

13. The computer system as claimed in claim 12, having a smart card (15) for each of the users and a smart card reader (14) on the client for the user to pay the amount of the order.

14. The computer system as claimed in one of the preceding claims 1 to 13, in which the administrator interface permits the manual entry of orders, payments and/or payments into the account of a user.

15. A server computer for a computer system as claimed in one of the preceding claims 1 to 14.

16. A client computer for a computer system as claimed in one of the preceding claims 1 to 14.

17. The client computer as claimed in claim 16, in which the client computer is in the form of a mobile computer, mobile telephone, Personal Digital Assistant, Web Pad or other mobile communication means.

18. A method for ordering a product, having the following steps:
a list of products is visualized on the client of a user,
one or more of the products is/are selected from the list of products by the user, and the selected products are ordered by the user,
the amount of the order is charged to an account of the user.

19. The method as claimed in claim 18, in which the product is food, drink or tobacco, and the list of products is a menu.

20. The method as claimed in claim 18 or 19, in which an administrator has selected a standard list, for example in the form of a standard menu, from a selection of standard lists for producing the list of products.

21. The method as claimed in one of claims 18, 19 or 20, in which an administrator has created a special list, for example in the form of a special menu, for the list of products.

22. The method as claimed in one of claims 18 to 21, in which a check is carried out to determine whether the order by the user is covered by the account balance of the user.

23. The method as claimed in one of the preceding claims 18 to 22, in which the user receives a message if a first and/or a second credit limit is exceeded by the order.
